(19) United States
(12) Patent Application Publication
(10) Pub. No.: US 2013/0024124 A1
(43) Pub. Date: Jan. 24, 2013

(54) SYSTEMS, METHODS, AND APPARATUS FOR PREVENTING RECIDIVISM

(71) Applicants: Christopher J. Collazo, Manchester, CT (US); Karen W. Mealey, Avon, CT (US); Adam L. Seidner, Old Lyme, CT (US); Wayne Wendling, Chicago, IL (US); Takeshi Yamaguchi, Unionville, CT (US); Jonathan H. Gice, Avon, CT (US); Jared M. Yanowicz, Middletown, CT (US)

(72) Inventors: Christopher J. Collazo, Manchester, CT (US); Karen W. Mealey, Avon, CT (US); Adam L. Seidner, Old Lyme, CT (US); Wayne Wendling, Chicago, IL (US); Takeshi Yamaguchi, Unionville, CT (US); Jonathan H. Gice, Avon, CT (US); Jared M. Yanowicz, Middletown, CT (US)

(73) Assignee: THE TRAVELERS COMPANIES, INC., Hartford, CT (US)

(21) Appl. No.: 13/189,307

(22) Filed: Jul. 22, 2011

(51) Int. Cl. G06F 19/00

(52) U.S. Cl. 702/19

(57) ABSTRACT

Systems, apparatus, methods and articles of manufacture provide for assessing a likelihood of recidivism for persons (e.g., patients, injured workers). In some embodiments, information such as claim information, employment information, personal information, and/or medical information, may be used in determining a recidivism score or other indication or measure of a likelihood of recidivism.

### BACKGROUND

Physicians and other medical and health care providers typically consider a patient's medical history and current medical condition(s) in prescribing an appropriate medical treatment regimen for illnesses, bodily injuries, disabilities, and other types of medical conditions. Medical and health care providers, insurance carriers, and other types of entities assess and project the costs associated with providing medical treatments. Recurrence, re-injury, occurrence of a new medical condition, exacerbation, aggravation, relapse, or other types of recidivism in a patient (e.g., after receiving initial medical treatment), however, may increase the costs of providing treatment and/or may increase adverse effects of the initial medical condition, accident, or loss event (e.g., by extending the amount of time an injured person is unable to work). In the context of workers' compensation insurance, recidivism may refer to those claims where an injured worker failed at an attempt to return to work, resulting in more than one disability period. Yet despite the importance to the medical and insurance industries of preventing recidivism in persons suffering from injury, illness and other types of medical conditions, previous systems and practices have failed to optimize the assessment of the likelihood of recidivism, or prevention of recidivism.

### BRIEF DESCRIPTION OF THE DRAWINGS

An understanding of embodiments described in this disclosure and many of the attendant advantages may be readily obtained by reference to the following detailed description when considered with the accompanying drawings, wherein:

FIG. 1A is a diagram of a system according to some embodiments of the present invention;

FIG. 1B is a diagram of a management system according to some embodiments of the present invention;

FIG. 2 is a diagram of a computer system according to some embodiments of the present invention;

FIG. 3 is a flowchart of a method according to some embodiments of the present invention;

FIG. 4 is a flowchart of a method according to some embodiments of the present invention;

FIG. 5 is a flowchart of a method according to some embodiments of the present invention;

FIG. 6A depicts an example user interface according to some embodiments of the present invention; and

FIG. 6B depicts an example user interface according to some embodiments of the present invention.

### DETAILED DESCRIPTION

Applicants have recognized that, in accordance with some embodiments described in this disclosure, medical care providers, insurance providers, claim professionals and others assessing the likelihood of recidivism for a person (e.g., recurrence of a medical condition and/or occurrence of one or more new, related or unrelated medical conditions in a medical patient or an injured worker), may find it beneficial (i) to establish coefficients and other factors useful for assessing the likelihood of recidivism in a person (e.g., for use in calculating a recidivism score); (ii) to assess a likelihood of recidivism in a person's medical condition (e.g., by calculating a recidivism score); and/or (iii) to provide for more accurate case management by recommending one or more actions (e.g., to a patient, to an injured worker, to a medical care provider and/or to a claim professional) based on assessment of a likelihood of recidivism (e.g., to reduce the likelihood of recidivism). Some embodiments described in this disclosure provide for the aggregation, analysis and preparation of data (e.g., historical claim and/or patient data) for use in providing one or more of the beneficial functions described above.

Applicants have recognized that it may be beneficial, in accordance with some embodiments, to create and/or access available data stores of sufficient detail that a medical or claim professional entering minimal information regarding an injured person (e.g., a patient identifier, a claim identifier, category of a bodily injury, age, and one or more relevant comorbidities of a patient or claimant) may be presented with an assessment of a likelihood of recidivism and/or recommendations related to treatment of the injured person.

Applicants have recognized that it would be desirable, in accordance with some embodiments, to provide a user interface for assessing the likelihood of recidivism in one or more patients. In one embodiment, a user interface (e.g., provided via an application, such as a web browser, running on or presented via a computing device) allows for receiving information (e.g., from a medical or claim professional or other user, or from a server computer) for determining the likelihood of recidivism. Alternatively or in addition, the determined likelihood may be received from another computing device (e.g., a remote server, a web server) and/or may be presented to the user via the interface (e.g., by displaying or otherwise communicating the determined likelihood to the user).

Applicants have recognized that it would be desirable, in accordance with some embodiments, to provide a user interface for providing recommendations of one or more actions based on a likelihood of recidivism. In one embodiment, a user interface (e.g., provided via an application, such as a web browser, running on or presented via a computing device) allows for receiving information (e.g., from a medical or claim professional or other user, or from a server computer) for determining one or more recommendations for reducing recidivism. Alternatively or in addition, the determined recommendation(s) may be received from another computing device (e.g., a remote server) and/or may be presented to the user via the interface (e.g., by displaying or otherwise communicating the determined recommendation(s) to the user).

Various embodiments discussed in this disclosure allow for determining a likelihood of recidivism in various medical and/or insurance contexts. In the context of workers' compensation insurance claims, recidivism may relate to situations where an injured worker experiences a recurrence, exacerbation, or aggravation of a medical condition and/or an occurrence of a new medical condition after they have returned to full duty work that results in additional time lost from work. Applicants have recognized that it would be desirable, in accordance with some embodiments, to provide a system, method and article of manufacturer for determining the likelihood of recidivism and/or multiple disability periods early in the life of a workers' compensation claim. A model in accordance with some embodiments allows for predicting a likelihood of recidivism when an injured worker is released to return to work. Such a determination may, for example, enable some insurance carriers to undertake better claim handling practices and/or manage medical care more efficiently, which might prevent possible recidivism, thus resulting in significant cost savings and higher customer satisfaction. In particular, some embodiments allow for the providing of an alert to a claim professional/adjuster and/or nurse or medical case manager when an injured worker is classified as having a high likelihood of recidivism and/or suggesting one or more intervention strategies designed to reduce the likelihood of recidivism and the costs associated with it.

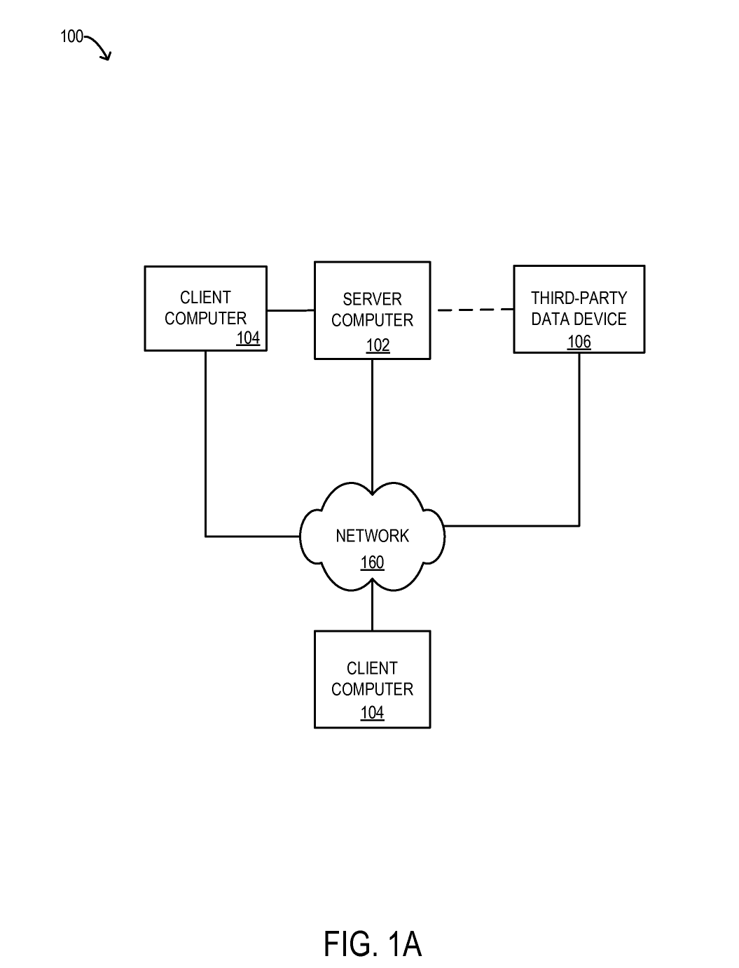

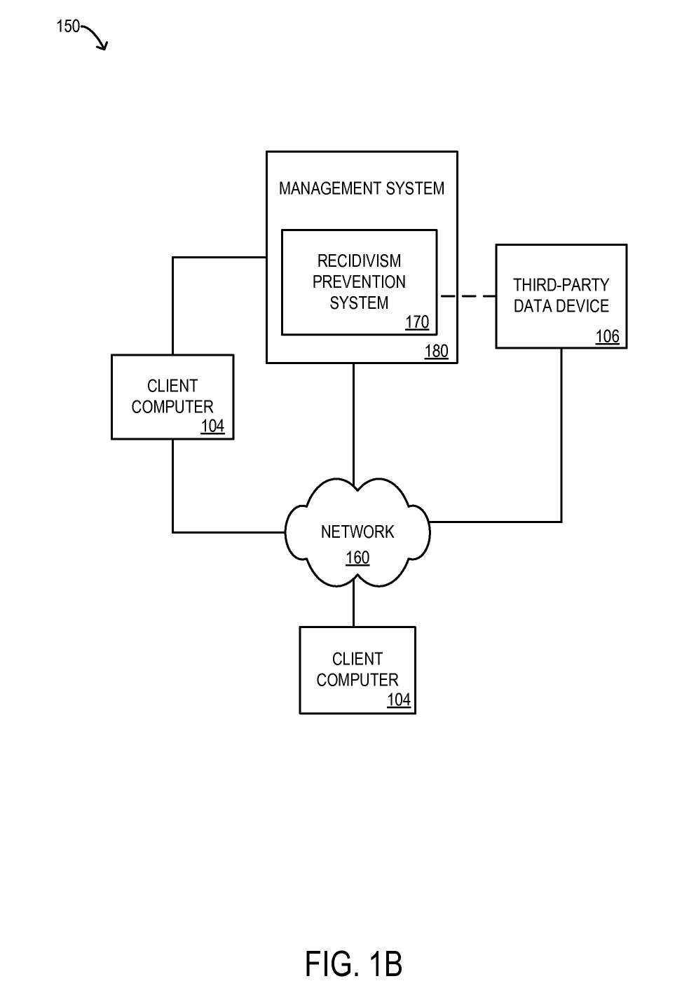

FIG. 1A depicts a block diagram of an example system 100 according to some embodiments. The system 100 may comprise one or more client computers 104 in communication with a controller or server computer 102 via a network 160. Typically a processor (e.g., one or more microprocessors, one or more microcontrollers, one or more digital signal processors) of a client computer 104 or server computer 102 will receive instructions (e.g., from a memory or like device), and execute those instructions, thereby performing one or more processes defined by those instructions. Instructions may be embodied in, e.g., one or more computer programs and/or one or more scripts.

In some embodiments a server computer 102 and/or one or more of the client computers 104 stores and/or has access to data associated with one or more individuals, and useful for assessing a likelihood of recidivism for, a person (e.g., recidivism of an injured person's medical condition) and/or determining at least one recommendation for preventing or reducing recidivism. Such information may include one or more of: (i) a person's medical history, (ii) information about a person's current medical condition (e.g., a bodily injury, comorbidity information), (iii) other personal information about a person (e.g., age, marital status), (iii) historical claim data (e.g., for past medical injury claims of a person), (iv) recommended treatment procedures (e.g., for treatment of an injury), (v) information about a person's employment and/or place of employment, and/or (vi) one or more recidivism coefficients. In one example, historical claim data and/or coefficients may be specific to one individual (e.g., an injured worker). In another example, such information may be associated with more than one person, claimant, company, insured, state and/or other useful population, as desired for a particular implementation.

According to some embodiments, any or all of such data may be stored by or provided via one or more optional third-party data devices 106 of system 100. A third-party data device 106 may comprise, for example, an external hard drive or flash drive connected to a server computer 102, a remote third-party computer system for storing and serving data for use in assessing a likelihood of recidivism, or a combination of such remote and local data devices. A third-party entity (e.g., a party other than an owner and/or operator, etc., of the server computer 102, client computer 104 and other than an end-user of any data used in recidivism assessment) may comprise, without limitation, (i) a third-party vendor collecting data on behalf of the owner, a marketing firm, government agency and/or regulatory body, and/or (ii) a demographic data gathering and/or processing firm. A third-party entity, such as a pharmacy, health care provider or retailer may, for example, collect and/or monitor patient, customer, sales and/or claim data for various purposes deemed useful by the third party, including, without limitation, data mining, data analysis, data aggregation, price tracking and/or sale or exchange of collected data. In one embodiment, any raw data, data analysis and/or metrics may be stored on and/or made available (e.g., to an insurer) via the third-party data device 106. In one embodiment, one or more companies and/or end users may subscribe to or otherwise purchase data (e.g., coefficient data and/or recommendation data) from a third party and receive the data via the third-party data device 106.

In some embodiments, health risk assessment (HRA) tools may facilitate the collection of health data for one or more individuals. For example, HRA tools such as kiosk-based diagnostic or data entry systems, web-based programs and applications, paper mailings, email communications, telephonic surveys and/or other types of information collection may allow for users to self report health data. Accordingly, in some embodiments, third-party sources of HRA surveys, such as by government and/or commercial health care insurers and researchers, could be stored on, received from and/or made accessible via third-party device(s) 106.

In some embodiments, a client computer 104, such as a computer workstation or terminal of a claim professional of an insurance company, is used to execute a recidivism assessment application, stored locally on the client computer 104, that accesses information stored on, or provided via, the server computer 102. In another embodiment, the server computer 102 may store some or all of the program instructions for assessing medical costs, and the client computer 104 may execute the application remotely via the network 160 and/or download from the server computer 102 (e.g., a web server) some or all of the program code for executing one or more of the various functions described in this disclosure.

In one embodiment, a server computer may not be necessary or desirable. For example, some embodiments described in this disclosure may be practiced on one or more devices without a central authority. In such an embodiment, any functions described herein as performed by a server computer and/or data described as stored on a server computer may instead be performed by or stored on one or more such devices. Additional ways of distributing information and program instructions among one or more client computers 104 and/or server computers 102 will be readily understood by one skilled in the art upon contemplation of the present disclosure.

FIG. 1B depicts a block diagram of another example system 150 according to some embodiments. The system 150 may comprise one or more client computers 104 in communication with a management system 180 (e.g., a patient management system, an insurance claim management system) via a network 160. In one embodiment, a management system 180 may be hosted by, for example, a server computer 102. A recidivism prevention system 170 is integrated into the central management system 180, for example, as a module or other functionality accessible through the management system 180.

In one embodiment, information about a particular claim, e.g., stored by a management system 180 for managing insurance claims, may be provided advantageously to the recidivism prevention system 170. For example, stored information about an injured claimant, such as age, state of residence, medical condition, and/or other information from the claimant's file, may be accessible by the recidivism prevention system 170 without requiring manual input by a claim professional. As discussed above with respect to system 100 of FIG. 1A, in some embodiments one or more third-party data devices 106 may store information used in assessing a likelihood of recidivism (e.g., probability of relapse of a claimed injury and/or a return to a disabled status).

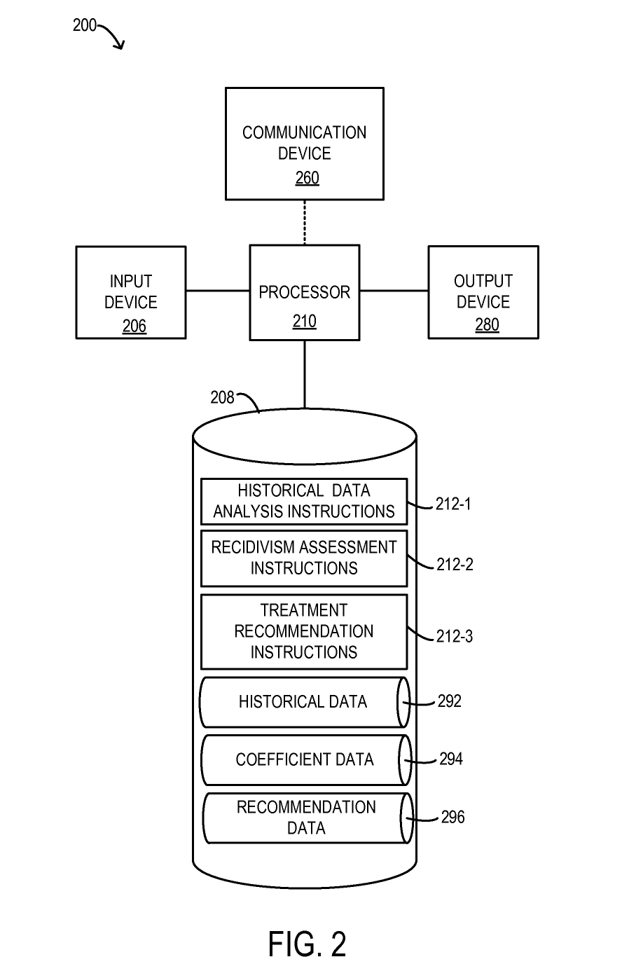

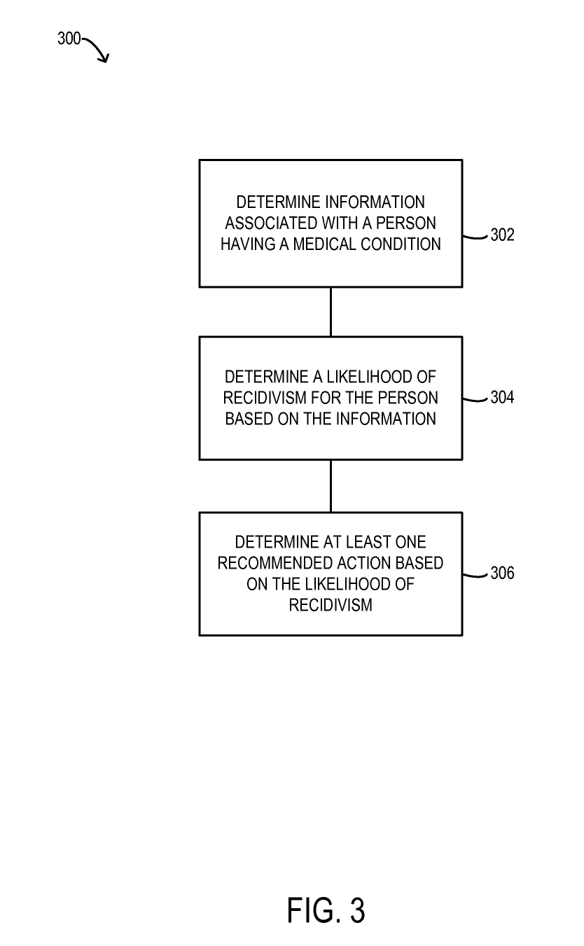

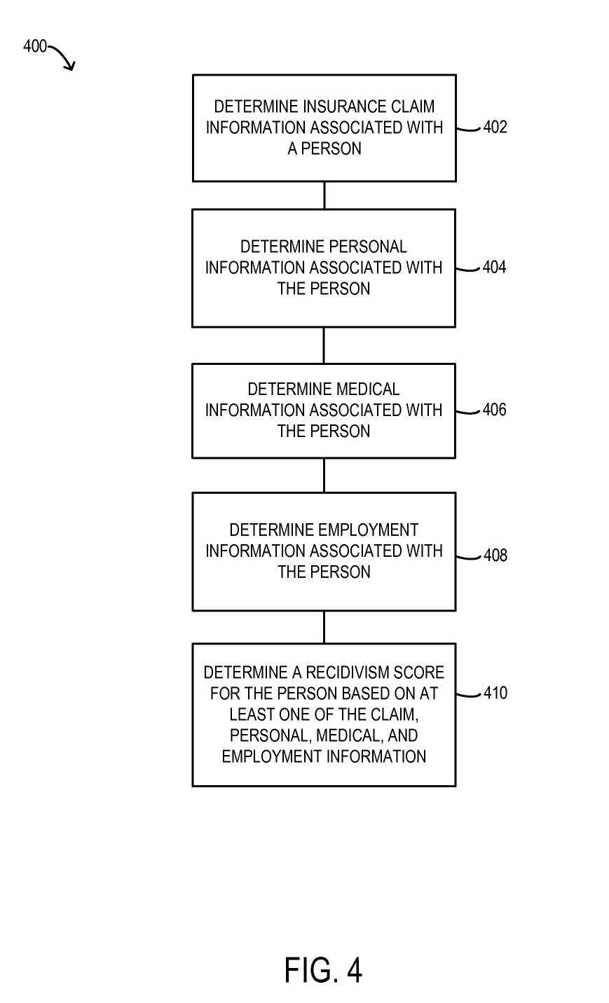

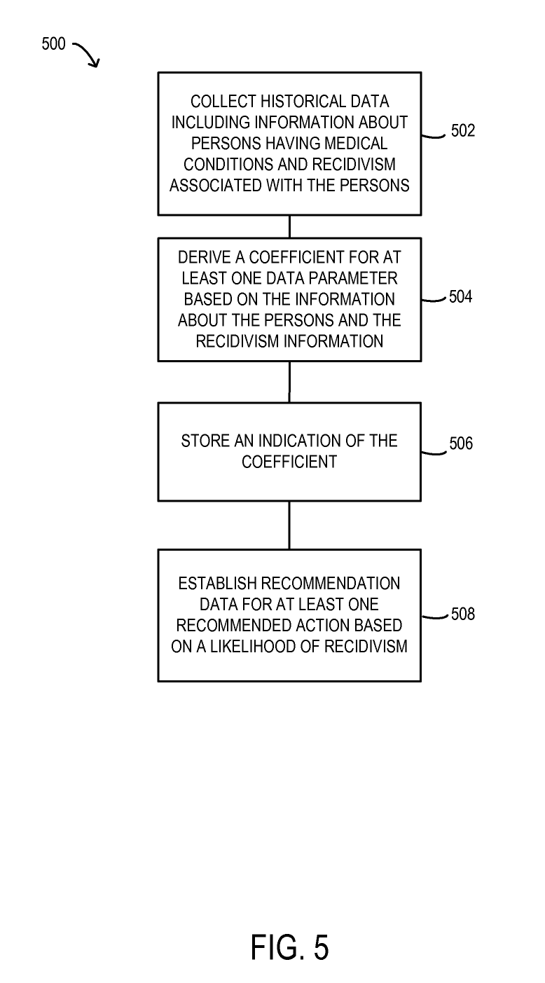

Turning to FIG. 2, a block diagram of an apparatus 200 according to some embodiments is shown. In some embodiments, the apparatus 200 may be similar in configuration and/or functionality to any of the client computers 104, server computers 102, third-party data devices 106, recidivism prevention system 170 and/or management system 180 of FIG. 1A and/or FIG. 1B. The apparatus 200 may, for example, execute, process, facilitate, and/or otherwise be associated with any of the processes 300, 400, and 500 described in conjunction with FIG. 3, FIG. 4, and FIG. 5 herein.

In some embodiments, the apparatus 200 may comprise an input device 206, a memory device 208, a processor 210, a communication device 260, and/or an output device 280. Fewer or more components and/or various configurations of the components 206, 208, 210, 260, 280 may be included in the apparatus 200 without deviating from the scope of embodiments described herein.

According to some embodiments, the processor 210 may be or include any type, quantity, and/or configuration of processor that is or becomes known. The processor 210 may comprise, for example, an Intel® IXP 2800 network processor or an Intel® XEON™ processor coupled with an Intel® E7501 chipset. In some embodiments, the processor 210 may comprise multiple inter-connected processors, microprocessors, and/or micro-engines. According to some embodiments, the processor 210 (and/or the apparatus 200 and/or other components thereof) may be supplied power via a power supply (not shown) such as a battery, an Alternating Current (AC) source, a Direct Current (DC) source, an AC/DC adapter, solar cells, and/or an inertial generator. In the case that the apparatus 200 comprises a server such as a blade server, necessary power may be supplied via a standard AC outlet, power strip, surge protector, and/or Uninterruptible Power Supply (UPS) device.

In some embodiments, the input device 206 and/or the output device 280 are communicatively coupled to the processor 210 (e.g., via wired and/or wireless connections and/or pathways) and they may generally comprise any types or configurations of input and output components and/or devices that are or become known, respectively.

The input device 206 may comprise, for example, a keyboard that allows an operator of the apparatus 200 to interface with the apparatus 200 (e.g., by a medical professional or claim professional) to assess a likelihood of recidivism for a particular person. In some embodiments, the input device 206 may comprise a sensor configured to provide information, such as encoded claim, patient, or claimant information to the apparatus 200 and/or the processor 210.

The output device 280 may, according to some embodiments, comprise a display screen and/or other practicable output component and/or device. The output device 280 may, for example, provide recidivism analysis to an insurance claim professional and/or medical care provider professional seeking to assess the likelihood of recidivism for a claimant/patient (e.g., via a computer workstation). According to some embodiments, the input device 206 and/or the output device 280 may comprise and/or be embodied in a single device such as a touch-screen monitor.

In some embodiments, the communication device 260 may comprise any type or configuration of communication device that is or becomes known or practicable. The communication device 260 may, for example, comprise a network interface card (NIC), a telephonic device, a cellular network device, a router, a hub, a modem, and/or a communications port or cable. In some embodiments, the communication device 260 may be coupled to provide data to a telecommunications device. The communication device 260 may, for example, comprise a cellular telephone network transmission device that sends signals (e.g., claim information) to a server in communication with a plurality of handheld, mobile and/or telephone devices. According to some embodiments, the communication device 260 may also or alternatively be coupled to the processor 210. In some embodiments, the communication device 260 may comprise an IR, RF, Bluetooth™, and/or Wi-Fi® network device coupled to facilitate communications between the processor 210 and another device (such as one or more client computers, server computers, central controllers and/or third-party data devices).

The memory device 208 may comprise any appropriate information storage device that is or becomes known or available, including, but not limited to, units and/or combinations of magnetic storage devices (e.g., a hard disk drive), optical storage devices, and/or semiconductor memory devices such as Random Access Memory (RAM) devices, Read Only Memory (ROM) devices, Single Data Rate Random Access Memory (SDR-RAM), Double Data Rate Random Access Memory (DDR-RAM), and/or Programmable Read Only Memory (PROM).

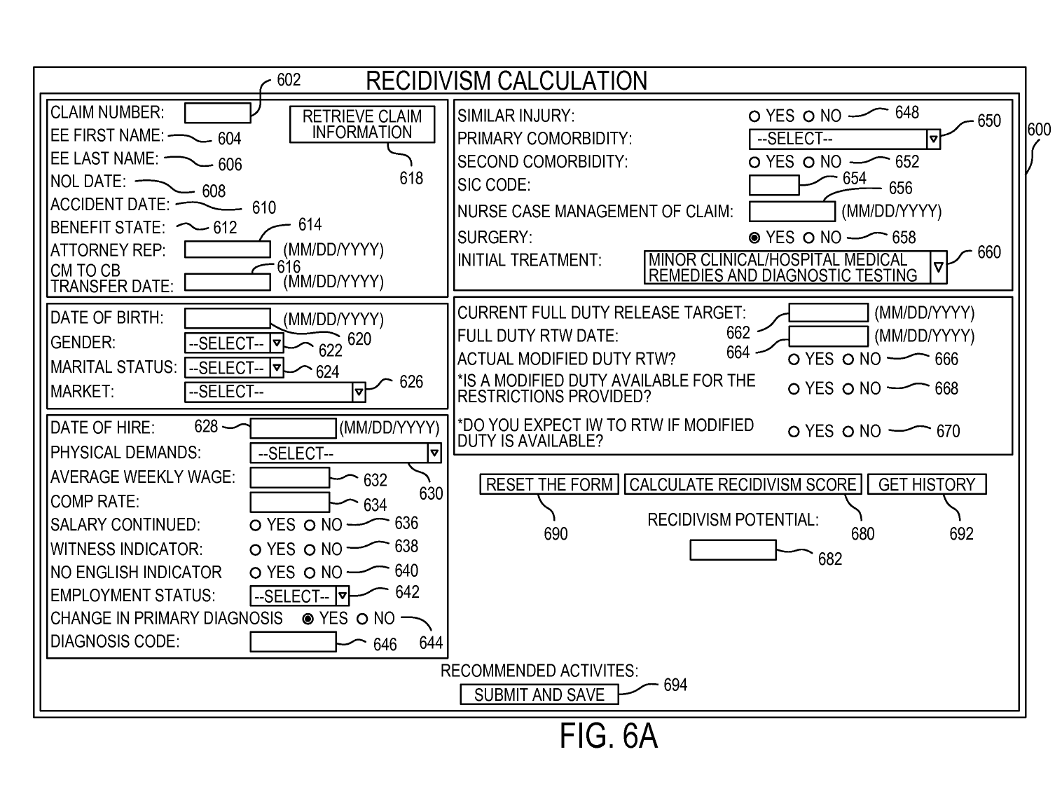

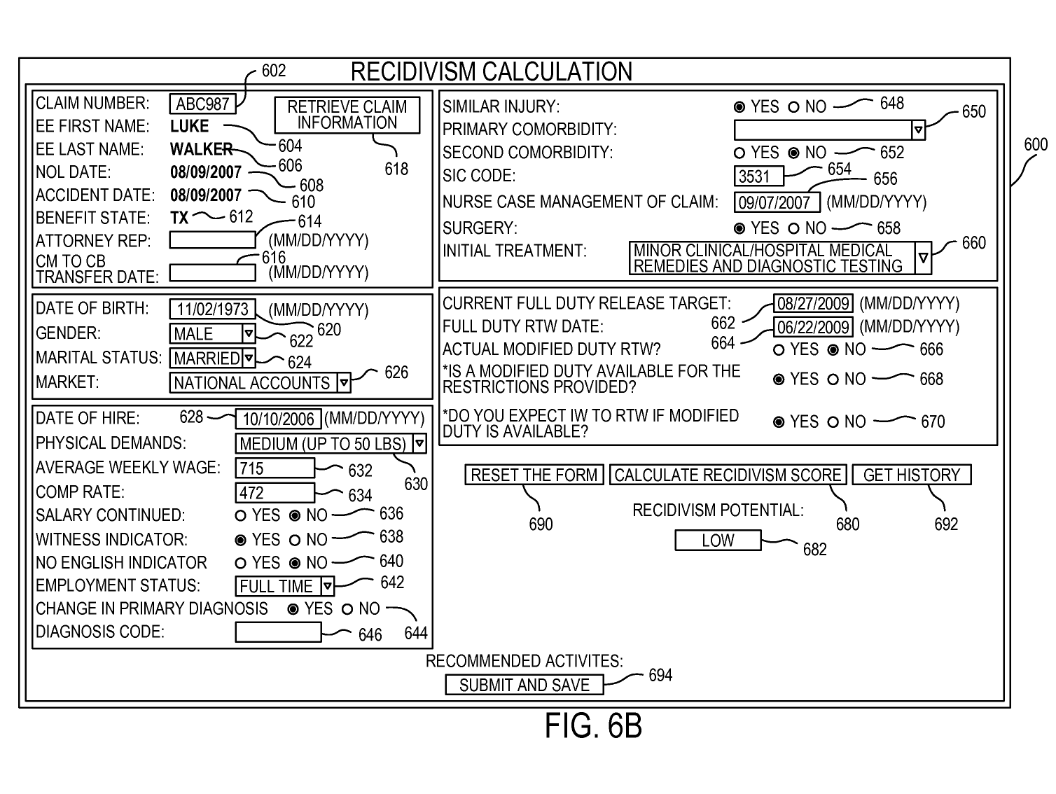

The memory device 208 may, according to some embodiments, store one or more of historical data analysis instructions 212-1, recidivism assessment instructions 212-2, treatment recommendation instructions 212-3, historical data 292, coefficient data 294, and/or recommendation data 296. In some embodiments, the historical data analysis instructions 212-1, recidivism assessment instructions 212-2, and/or treatment recommendation instructions 212-3 may be utilized by the processor 210 to provide output information via the output device 280 and/or the communication device 260 (e.g., via the user interface 602 of FIG. 6A and/or FIG. 6B, respectively).

According to some embodiments, historical data analysis instructions 212-1 may be operable to cause the processor 210 to process historical data 292 (e.g., historical claim data and/or historical medical data) as described herein. Historical data 292 received via the input device 206 and/or the communication device 260 may, for example, be data mined, analyzed, sorted, filtered, decoded, decompressed, ranked, scored, plotted, and/or otherwise processed by the processor 210 in accordance with the instructions of historical data analysis instructions 212-1 (e.g., in accordance with the method 500 of FIG. 5). In some embodiments, historical claim and/or medical care information may be fed by the processor 210 through one or more mathematical and/or statistical equations and/or models in accordance with instructions of historical data analysis instructions 212-1 to define one or more coefficients (e.g., described by the coefficient data 294) that may then be utilized for various purposes as described herein.

According to some embodiments, the recidivism assessment instructions 212-2 may be operable to cause the processor 210 to perform a recidivism assessment (e.g., for a claimed injury) as described herein. Historical data 292 and/or coefficient data 294 may be analyzed to determine a likelihood of recidivism for a given person (or a defined population of persons, such as injured workers), such as by calculating or otherwise generating a recidivism score. Historical data 292 and/or coefficient data 294 may be analyzed to determine at least one recommended action (e.g., procedure or prescription stored in recommendation data 296), for example, that may be recommended (e.g., to a claim professional, medical care professional and/or injured person) as potentially useful in reducing the likelihood of recidivism for a person. In one example, a recommended action may be directed to an injured worker for reducing the likelihood of relapse of an injury and/or reducing the total time between an accident and the worker's return to work at full duty. The recidivism assessment instructions 212-2 may, in some embodiments, utilize the coefficient data 294 to calculate a recidivism score for a given person.

The apparatus 200 may function as a computer terminal and/or server of an insurance and/or medical care provider, for example, that is utilized to process or manage insurance claims or patient files and/or assess a likelihood of recidivism. In some embodiments, the apparatus 200 may comprise a web server and/or other portal (e.g., an interactive voice response unit (IVRU)) that provides historical data 292, coefficient data 294 and/or recommendation data 296 to users, consumers and/or corporations.

Any or all of the exemplary instructions and data types described herein and other practicable types of data may be stored in any number, type, and/or configuration of memory devices that is or becomes known. The memory device 208 may, for example, comprise one or more data tables or files, databases, table spaces, registers, and/or other storage structures. In some embodiments, multiple databases and/or storage structures (and/or multiple memory devices 208) may be utilized to store information associated with the apparatus 200. According to some embodiments, the memory device 208 may be incorporated into and/or otherwise coupled to the apparatus 200 (e.g., as shown) or may simply be accessible to the apparatus 200 (e.g., externally located and/or situated).

In one embodiment, health and other medical information specific to a particular individual (e.g., an injured worker) may be received from a third party (e.g., a health care provider) via a third-party device 106, received from the injured worker, and/or stored on server computer 102.

Those skilled in the art will recognize that “comorbid” conditions or “comorbidity” conditions are conditions existing in a patient simultaneously with, but usually unrelated to or independent of, another identified medical condition, such as a pathological or disease process or injury. Comorbidity conditions may include, without limitation, one or more of the following:
Arthritis/Degenerative Joint Disease
Obesity/Nutritional Issues
Osteoporosis/penia
Diabetes Mellitus
Alcoholism
Substance Abuse
Deconditioning
Chronic Steroid Use
Immune Deficiency
Smoker
Autoimmune disorder
Chronic Obstructive Pulmonary Disease
Cardiovascular
Renal
   Applicants have recognized that the likelihood of recidivism associated with treatment of some types of medical conditions, such as a bodily or musculoskeletal injury, may be correlated significantly to the presence of one or more comorbidity conditions. Applicants have further recognized that a plurality of comorbidity conditions may increase the likelihood of recidivism. Some embodiments described in this disclosure provide for determining a likelihood of recidivism based on one or more comorbidity conditions, considerations or coefficients.

As discussed in this disclosure, a determination of the existence of a comorbidity condition, such as obesity, may be useful, in some embodiments, for assessing the likelihood of recidivism for a patient or claimant with a claim. More direct measurements of the health status of a particular individual, however, may allow for assessing a level, degree or other more precise measure of a condition that may be useful, in accordance with some embodiments, for improving the accuracy of assessing the likelihood of recidivism (and/or for one or more individuals having a similar health status). Such coefficients may allow for a more accurate prediction of medical service utilization, lost time days and/or intervention strategies.

In one embodiment, more precise comorbidity coefficients may be determined based on a degree of the particular condition. In one example, physician providers, pharmacy clinics and physical therapy offices can measure height weight, and skin folds in order to determine body mass index (BMI), body adipose index (BAI), strength, range of motion and/or flexibility. Such direct measurements, for example, may allow for a measure of the degree of obesity or deconditioning for a particular individual. The degree of severity of obesity and musculoskeletal health may allow for new intervention strategies and more accurate assessments of potential medical costs associated with the individual. In one example, obesity coefficients may be developed based on a degree of being overweight or obesity. Application of a coefficient or multiplier, in some embodiments, thus allows for an assessment of likelihood of recidivism for a person that takes into account not only the mere existence of at least one comorbidity condition, but a degree or level of the associated condition(s).

Although the particular values of the coefficients described in this disclosure may be equal to or greater than 1.00, it will be readily understood that such values may be less than 1.00, or may be any appropriate value for assessing the effect of one or more conditions or characteristics on determining the likelihood of recidivism. In one embodiment, the appropriate coefficients may be stored as percentages, ratios and/or other mathematical equivalents suitable for the desired implementation.

Referring now to FIG. 3, a flow diagram of a method 300 according to some embodiments is shown. The method 300 may, for example, be performed by or on behalf of an insurer, a claim professional, a medical care facility and/or an insured person or other user. It should be noted that although some of the steps of method 300 may be described herein as being performed by a client computer while other steps are described herein as being performed by another computing device, any and all of the steps may be performed by a single computing device, which may be a client computer, server computer, third-party data device or another computing device. Further, any steps described herein as being performed by a particular computing device may be performed by a human or another computing device as appropriate.

According to some embodiments, the method 300 may comprise determining information associated with a person having a medical condition, at 302. The information may comprise one or more of: a person's medical history, claim information about an insurance claim associated with the person, other personal information (e.g., age, residence, marital status), and/or information about the person's employment (e.g., physical demands of the job, length of employment, compensation or salary information). Determining the information may comprise one or more of: reviewing the person's medical history, accessing stored electronic data; receiving the information via a user interface (e.g., from a claim professional or other user) or input device; and receiving a signal including an indication of the information from a client computer, web server, server computer, recidivism prevention system or third-party data device.

According to some embodiments, the method 300 may comprise determining a likelihood of recidivism based on the information, at 304. Determining the likelihood of recidivism may comprise (i) determining at least one coefficient associated with a data parameter (e.g., an age or age range) and (ii) generating a recidivism score or other indication of a likelihood of recidivism (e.g., based on one or more coefficients).

According to some embodiments, the method 300 may comprise determining at least one recommended action based on the likelihood of recidivism, at 306. Various ways of determining recommendation actions and various types of recommended actions are discussed in this disclosure, and others will be apparent to those skilled in the art upon contemplation of this disclosure.

In some embodiments, the determined likelihood of recidivism and/or at least one recommended action may be communicated to a client computer, server computer, third-party data device and/or to a claim professional or other user (e.g., represented on a display device of a computer).

Referring now to FIG. 4, a flow diagram of a method 400 according to some embodiments is shown. The method 400 may, for example, be performed by or on behalf of an insurer, a claim professional, a medical care facility and/or an insured person or other user. It should be noted that although some of the steps of method 400 may be described herein as being performed by a client computer, while other steps are described herein as being performed by another computing device, any and all of the steps may be performed by a single computing device, which may be a client computer, server computer, third party data device or another computing device. Further, any steps described herein as being performed by a particular computing device may be performed by a human or another computing device as appropriate.

According to some embodiments, the method 400 may comprise determining insurance claim information associated with a person, at 402. Insurance claim information associated with a person may comprise, without limitation, one or more of: a date of an accident involving the person, a geographical jurisdiction associated with a claim, an indication of whether there was a witness to an injury, a date of attorney representation, a current full duty release target date, an SIC code, a full duty return to work date, an indication of whether there was an actual modified duty return to work, an indication of whether modified duty is available, and an indication of whether the person is expected to return to work if modified duty is available. Determining the insurance claim information may comprise one or more of: reviewing claim information associated with a person, accessing stored electronic data including claim information; receiving an indication of claim information via a user interface (e.g., from a claim professional or other user) or input device; and receiving a signal including an indication of claim information from a client computer, server computer, recidivism assessment system or third-party data device. In one example of determining claim information, a claim professional enters an identifier that identifies a claim via a user interface (e.g., by typing a claim number in a text box). In another example, a recidivism assessment application sends a request (e.g., including information identifying a person, claimant and/or injured person) to a computer (e.g., a server computer) for claim information associated with a person and the server returns the claim information.

According to some embodiments, the method 400 may comprise determining personal information associated with the person (e.g., personal information other than claim information, medical information or employment information), at 404. Such personal information may include, without limitation, one or more of: a date of birth of the person, a gender of the person, an indication of whether the person speaks a predetermined language (e.g., English, Spanish), financial information (e.g., credit score) and a marital status of the person.

According to some embodiments, the method 400 may comprise determining medical information associated with the person, at 406. Such medical information may include, without limitation, at least one of: an injury type, an indication of a similar injury, an indication of an initial treatment of the medical condition, an indication of a change in a primary diagnosis, at least one comorbidity of the person, an indication of a diagnosis and/or diagnosis code (e.g., International Classification of Disease (ICD) codes), an indication of a treatment and/or procedural codes (e.g., National Counsel of Compensation Insurance (NCCI) codes, Current Procedural Terminology (CPT) codes), and/or an indication of whether a surgery was performed on the person. Types of injuries that may be entered, stored and/or assessed in accordance with various embodiments of the present invention may include, but are not limited to, one or more of the following:
ACL Tear
Ankle Complex/Crush Fracture
Ankle Simple Fracture
Ankle Strain/Sprain
Carpal Tunnel Non-Surgical
Carpal Tunnel Surgical
Cervical Disc No Surgery
Cervical Disc Surgery
Cervical Fusion
Cervical Strain/Sprain Whiplash
Elbow Complex/Crush Fracture
Elbow Simple Fracture
Elbow Strain/Sprain
Femur Complex/Crush Fracture
Femur Simple Fracture
Finger Complex/Crush Fracture
Finger Simple Fracture
Finger Strain/Sprain
Foot Complex/Crush Fracture
Foot Simple Fracture
Foot Strain/Sprain
Hand Complex/Crush Fracture
Hand Simple Fracture
Hand Strain/Sprain
Hernia
Hip Fracture
Hip Strain/Sprain
Humerus Complex/Crush Fracture
Humerus Simple Fracture
Knee Fracture
Knee Strain/Sprain
Lumbar Disc No Surgery
Lumbar Disc Surgery
Lumbar Fusion
Lumbar Spine Strain/Sprain
Meniscus Tear
Radius & Ulna Complex/Crush Fracture
Radius & Ulna Simple Fracture
Rotator Cuff Tear Partial or Full
Shoulder Strain/Sprain
Tibia/Fibula Complex/Crush Fracture
Tibia/Fibula Simple Fracture
Toe Complex/Crush Fracture
Toe Simple Fracture
Toe Strain/Sprain
Wrist Complex/Crush Fracture
Wrist Simple Fracture
Wrist Strain/Sprain

According to some embodiments, determining a type of injury to a person (e.g., associated with a medical injury claim) may comprise one or more of: reviewing the injured person's medical history, accessing stored electronic data including information about the injured person's health; receiving an indication of the type of injury via a user interface (e.g., from a claim professional or other user) or input device; and receiving a signal including an indication of the type of injury from a client computer, server computer, recidivism assessment system or third-party data device.

In one example of determining the type of injury, a claim professional enters the type of injury via a user interface (e.g., by entering the type of injury in a text box, by selecting a type of injury from a displayed list of selectable injury types). In another example, a recidivism assessment application sends a request (e.g., including information identifying the injured person) to a computer (e.g., a server computer) or claim management system for the injury that is the subject of a claim and the server returns the type of injury.

According to some embodiments, the method 400 may comprise determining employment information associated with the person, at 408. Such employment information may include, without limitation, at least one of: a date of hire of the person, an indication of physical demand of the person's employment, an average wage, a compensation rate, an indication of whether salary is continued (e.g., while an injured worker is unable to work), and an employment status.

According to some embodiments, the method 400 may comprise determining a recidivism score for the person based on at least one of the claim information, personal information, medical information, and employment information, at 410. Various ways of determining the recidivism score based on one or more of such types of information are discussed in this disclosure; other ways may be apparent to those skilled in the art upon contemplation of this disclosure.

Referring now to FIG. 5, a flow diagram of a method 500 according to some embodiments is shown. The method 500 may, for example, be performed by or on behalf of an insurer, a claim professional, a medical care facility and/or an insured person or other user, in order to establish one or more types of information (e.g., in one or more databases) that may be useful, in one or more embodiments, in assessing a likelihood of recidivism. It should be noted that although some of the steps of method 500 may be described herein as being performed by a server computer, while other steps are described herein as being performed by another computing device, any and all of the steps may be performed by a single computing device which may be a client computer, server computer, third party data device or another computing device. Further any steps described herein as being performed by a particular computing device may be performed by a human or another computing device as appropriate.

In some embodiments method 500 may comprise collecting historical data including information about persons having medical conditions and an indication of any associated recidivism, at 502. For example, historical claim and/or patient information stored by one or more insurance companies and/or hospitals or other medical care facilities may be selected and/or aggregated, such claim information including, without limitation, one or more of: indications of patient comorbidities present with the injury, ICD codes associated with injuries (e.g., ICD-9 codes), medical procedure codes (e.g., CPT codes) related to medical treatment of injuries, indications of medical care procedures provided in treating an injury, physical demands of employment of injured persons, standard industry classification (SIC) codes, average wages, geographical jurisdiction associated with insurance claims, whether injured persons or claimants were represented by an attorney, whether there was any associated recidivism (e.g., a relapse in a medical condition, or an additional disability period associated with a respective insurance claim), and/or persons' ages.

In some embodiments method 500 may comprise deriving a coefficient for at least one data parameter (e.g., an age of a person and/or a comorbidity condition) based on the information about the persons and the recidivism information, at step 504, and storing an indication of the coefficient, at step 506. Deriving the coefficient may comprise, for example, identifying records in the collected historical data indicating one or more particular comorbidity conditions (e.g., obesity, diabetes mellitus or osteoporosis), ages, and whether or not there was a relapse or recidivism in a person's medical condition (e.g., failed attempt of an injured worker to return to work resulting in more than one disability period). Controlling for such variables, using well known techniques for statistical analysis, a coefficient for a given data parameter may be determined (e.g., by or on behalf of an insurance company, medical care provider, or third party data service) to represent the variation from the rate of recidivism experienced by other persons (e.g., other injured workers) without that condition. Some data analysis techniques for identifying significant variables and/or controlling for variables to derive coefficients and other quantitative and qualitative descriptions of relationships among data populations are described in Tamhane and Dunlop, Statistics and Data Analysis from Elementary to Intermediate, Prentice Hall, 2000 and in Kamber, M., Data mining: Concepts and Techniques, Morgan-Kaufman, 2000, each of which is incorporated herein by reference. In some embodiments, patient/claimant segmentation and other data analysis, data management and data mining processes may rely on and/or adapt commercially available processes and products, such as the STATISTICA suite of analytics software products by StatSoft, Inc.

According to some embodiments, deriving coefficients may comprise examining historical data (e.g., in an insurance carrier's claim database) and creating a binary variable such that the variable takes a value of 1 if a given claimant has experienced recidivism and value of 0 if the claimant has not experience recidivism. The binary variable for recidivism is added to a dataset that contains variables that contain data on other characteristics of the claimant, such as the diagnosis, whether they are represented by an attorney, etc. The dataset may then be analyzed as input to a commercial statistical software package (e.g., SAS) in order to estimate the relationship between the claimant characteristics and the recidivism outcome to be predicted.

As noted above, numerous classes of techniques may be used to estimate the relationship, such as binary response models based on the principle of maximum likelihood (commonly known as logit or probit models), decision tree models, and neural networks. A generalized linear model is a generalization of the linear regression model such that (1) nonlinear, as well as linear, effects can be tested (2) for categorical predictor variables as well as for continuous predictor variables, using (3) any dependent variable whose distribution follows several special members of the exponential family of distributions (e.g., gamma, Poisson, binomial, etc.), as well as for any normally-distributed dependent variable. In the logit regression model, the predicted values for the dependent or response variable will never be less than (or equal to) 0, or greater than (or equal to) 1, regardless of the values of the independent variables. The model is, therefore, commonly used to analyze binary dependent or response variables (see also the binomial distribution). This is accomplished by applying the following regression equation (the term logit was first used by Berkson, 1944):

y=exp(b0+b1*x1+ . . . +bn*xn)/{1+exp(b0+b1*x1+ . . . +bn*xn)}.

Regardless of the regression coefficients or the magnitude of the x values, this model will always produce predicted values (predicted y's) in the range of 0 to 1. The name logit stems from the fact that one can easily linearize this model via the logit transformation. Suppose we think of the binary dependent variable y in terms of an underlying continuous probability p, ranging from 0 to 1. We can then transform that probability p as:

p′=log e{p/(1−p)}.

This transformation is referred to as the logit or logistic transformation. Note that p′ can theoretically assume any value between minus and plus infinity. Since the logit transform solves the issue of the 0/1 boundaries for the original dependent variable (probability), those (logit transformed) values could be used in an ordinary linear regression equation. In fact, if the logit transform is performed on both sides of the logit regression equation stated earlier, the standard linear multiple regression model can be obtained:

p′=(b0+b1*x1+ . . . +bn*xn)

As noted above, typically a logistic regression model is built when the response/dependent variable is a binary (0/1) value. In the context of recidivism, logistic regression can be performed as recidivism/event=1 and non-recidivism/nonevent=0. Accordingly, an appropriate logistic regression model will estimate the response/dependent variable as either 1 or 0. In other words, it will estimate the probability of the desired even (in this case, recidivism). Estimating the probability with a logistic regression model is desirable, for some embodiments, because with an ordinary linear regression model there is a possibility of getting estimates beyond 0 and 1 for response/dependent variables. In such a situation, it is hard to decide on the events and nonevents based on the model. With logistic regression, on the other hand, modelers are able to estimate the probability of events, instead of predicting the actual response/dependent (0/1) variable. It will be understood that while regressing the response/dependent variable with the independent variables, the independent variables'can assume any value between −∞ to +∞ on the right hand side of the equation while left hand side is the estimated probability between 0 and 1.

Assuming the probability of estimating the event to be “P,” then the odds of the event is defined as follows:

Odds of event=P/(1−P)

Empirically, “Odds of event” will lie in the range (0 to +∞). Taking the logarithm of Odds of event, the result lies in the range (−∞ to +∞). This log of odds of event is referred as “Logit.” The model equation may be as shown below:

Logit=Log of odds=Log(P/1−P)=−

[symbol]

According to the model, the predicted probability of response/dependent will always lie between 0 and 1 for any given value of the independent variables. The logistic function may be represented as

$$F ( \text{?} ) = P ( \text{?} ) = \frac{1}{1 + \text{?}} …$$

$$where$$

$$\text{?}$$

$$\text{?} \text{indicates text missing or illegible when filed}$$

and

P=Probability of an event (recidivism)

Logistic regression estimates the model coefficients (β) by the method of maximum likelihood (ML) estimation. The response/dependent in the logistic regression model is binary, which takes on two values. Consider the below mentioned equation, which is log of odds for event as a linear function of the independent variable.

Log(P/1−P)=

[symbol]

Unfortunately, the values for the dependent variable (i.e., the log of odds) are not available, so the parameters cannot be estimated directly. However, the likelihood function provides a solution to this problem. The method of maximum likelihood selects values of the model parameters (β) that produce a distribution which gives the observed data the greatest probability (i.e., parameters that maximize the likelihood function). The maximum likelihood equation is derived from the probability distribution of the dependent variable. Each Yᵢ represents a binomial (0/1) count in the i^{th} population. Consequently, for the i^{th} observation,

P=

[symbol]

Assuming that all the n observations are independent, the likelihood function is given by

$$L = {\prod }_{\text{?}}^{n} p \text{?} ( 1 - \text{?} ) \text{?}$$

$$\text{?} \text{indicates text missing or illegible when filed}$$

On substituting value of probabilities in terms of parameters and solving it iteratively using the Newton-Raphson method, estimates of parameters may be derived.

In one example, a model equation may be developed for one explanatory variable, gender:

Log(P/1−P)=1.3+1.6*Gender(F)+ . . .

This means that the coefficients in logistic regression are in terms of the log odds, that is, the coefficient 1.6 implies that a one unit positive change in gender (F) results in a 1.6 unit change in the log of the odds as compared to the base group of gender=Male. The sign of the coefficient estimate has an impact on the probability of event. A positive sign implies higher probability while the negative sign implies lower probability. The coefficient estimates are used to determine the relation between the dependent and independent variables.

To find the probability of event (recidivism) for a given claim, the logistic function may be used as mentioned above along with the estimated intercept and coefficients. Starting with a base model equation,

P(Recidivism)=1/(1+e^{-(intercept+coefficient of gender*value of the input variable for gender+ . . . )}),

the equation may be developed using the example coefficient estimates discussed above to provide the sample equation,

P(Recidivism)=1/(1+e^{-(1.3+1.6*1(when Gender=F)+ . . . )}).

The sample equation above helps in identifying the injured worker's characteristics or claim handling behaviors that might have an impact on the probability of recidivism.

With respect to other types of analytic procedures, decision tree models, such as classification and regression trees, are analytic procedures for predicting the values of a continuous response variable (e.g., age) or categorical response variable (e.g., Marital Status: Single, Married, Divorced) from continuous or categorical predictors. When the dependent or response variable of interest is categorical in nature, the technique is referred to as classification trees; if the response variable of interest is continuous in nature, the method is referred to as regression trees. For classification problems, the goal is generally to find a tree where the terminal tree nodes are relatively “pure,” i.e., contain observations that (almost) all belong to the same category or class. For regression tree problems, node purity is usually defined in terms of the sums-of-squares deviation within each node. At each step, the program will find a logical split condition to assign observations to the two child nodes; for continuous predictors these logical conditions are usually of the type: If x>Value then NodeID=k; for categorical predictors, the logical split conditions are usually of the type: If x=Category I then NodeID=k.

Neural networks are analytic techniques modeled after the (hypothesized) processes of learning in a cognitive system and the neurological functions of the brain, and capable of predicting new observations (on specific variables) from other observations (on the same or other variables) after executing a process of so-called learning from existing data.

Once the relationship between recidivism and claimant characteristics is estimated, a user (through a computer program) can enter the characteristics of a claimant right before the initial return to work episode, before it is known whether the claimant will experience recidivism. Based on the claimant's characteristics, the computer will then calculate a score that tells the user if the claimant has a high likelihood of experiencing recidivism.

Many different types of characteristics may be analyzed in accordance with statistical techniques. Some examples of such characteristics include, without limitation:
Accident year
SIC code/code range (e.g., 1000 to <1500 (Mining); 4000 to <5000 (Utility))
Market segment
Area/Jurisdiction (e.g., state, province)
Age/Age range (e.g., 25 to <35 years of age)
Tenure/Tenure range (e.g., 6 months to <2 years)
Marital status (e.g., married, divorced, single, other)
Employment status (e.g., full time, part time, other)
Physical demands of work (e.g., none/unknown, sedentary, low, medium, heavy, very heavy)
Type of initial treatment
   None/Unknown
   Minor on-site remedies by employer medical staff (first aid)
   Minor clinical/hospital medical remedies and diagnostic testing
   Emergency evaluation, diagnostic testing, and medical procedures
   Hospitalization >24 hours
   Invalid
Gender (e.g., male, female, unknown)
English speaker (e.g., yes, no)
Witness to accident (e.g., yes, no)
Wage quantiles/Weekly wage
Compensation/Wage ratio
   Ratio=Compensation rate divided by weekly wage
   Ratio=0 if compensation rate >weekly wage or if weekly wage <=0
Primary comorbidity type
Second comorbidity (e.g., yes, no)
Change in primary diagnosis (e.g., yes, no)
Nurse/Medical case manager assigned (e.g., yes, no)
Early nurse/medical management
   Yes (e.g., interval between notice of loss date and nurse management date <=15 days)
   No
Surgery performed (e.g., yes, no)
Attorney representation
   Yes (e.g., attorney representation date is prior to full return to work date)
   No
Early attorney representation
   Yes (e.g., interval between notice of loss date and attorney representation <=15 days)
   No
Medical only claim history
   Yes (e.g., claim was transferred from a medical only claim to a lost time claim, a date of transfer to lost time claim exists)
   No
Initial treatment professional type (e.g., physician, hospital outpatient, hospital inpatient, other)
Similar injury
   Yes (e.g., current injury is similar to a previous injury)
   No
Notice of loss lag (interval between accident date and notice of loss date) (e.g., less than 3 days, less than 2 weeks, less than 3 months, greater than 3 months)
Salary continued (e.g., yes, no/unknown)
Light duty prior to full return to work (e.g., no, yes/actual return to work on modified duty or modified duty available and return to work expected)
Natural logarithm of target days
Initial injury type (e.g., based on segmentation of diagnosis code(s))

Some of the claimant characteristics that Applicants have found may have a statistically significant impact on the recidivism rate and/or projected likelihood of recidivism include:
jurisdiction (e.g., CA, TX, TN, NC, NY, NJ showed higher rate of recidivism while IL, MA, MI showed a lower rate),
type of injury (e.g., claimants with back, knee and carpal tunnel are associated with a higher probability of recidivism),
comorbidity,
personal characteristics (e.g., middle-aged, female, high average weekly wage (AWW) are associated with an increased probability of recidivism), and
claim characteristics (e.g., light duty, surgery, medical/nurse case management decrease recidivism; litigation, return to work before target date increase recidivism).

The characteristics for a given patient or claimant may need to be derived, in some embodiments, from other information (e.g., claim information), based on one or more transformation rules. For example, a notice of loss lag may be derived based on an accident date and the notice of loss date. In some embodiments, data input may be assigned to a particular characteristic range. For example, a person's date of birth may be used to derive an age group or tier (e.g., 45 to <55 years of age) for the person; similarly, a tenure group or tier may be derived based on a date of hire. In another example, a specific diagnosis code may be used to determine a class of injury type (e.g., upper body cut) that is statistically useful as a characteristic in the desired analysis. In another example, a compensation/wage ratio may be determined by dividing the compensation rate by the weekly wage.

In one example analysis, an insurance company wants to determine a coefficient that may be useful in projecting the likelihood of recidivism for a bodily injury in persons who also have a diabetes mellitus condition. The company stores or otherwise has access to a database (or databases) of information on past injury claims, and corresponding medical information for the injured persons. The company identifies, for types of injuries of interest (e.g., all bodily injuries, the fifty most common musculoskeletal injuries), a population of the injured persons who had diabetes mellitus at the time of their injuries, and identifies a second sample of injured persons who did not have diabetes mellitus. In one example, a frequency distribution (e.g., as a histogram) of whether an attempt to return to work resulted in more than one disability period for all types of injuries may be determined for patients without the diabetes condition (e.g., as a control) and the distribution may be compared to a frequency distribution for patients with the diabetes condition, to derive a coefficient using any of various well known techniques The derived coefficient preferably is stored in association with the corresponding diabetes mellitus condition (e.g., in a database) for use in assessing likelihood of recidivism for injuries and/or injury claims. Alternatively, or in addition, such coefficients may be derived periodically or in real-time based on current data, as desired for particular implementations.

Coefficients representing the presence of different data parameters and/or multiple such parameters may be derived similarly by analyzing the historical data associated with persons being associated with certain conditions or characteristics in light of the cost data associated with patients without such conditions or characteristics (e.g., comparing a population of patients over 40 years of age and having very physically demanding jobs with another population of patients without both of those characteristics). Such coefficients may be stored, in some embodiments, as coefficient data 294, e.g., as depicted in FIG. 2.

In some embodiments method 500 may comprise establishing recommendation data for at least one recommended action based on a likelihood of recidivism (e.g., in a workers' compensation claim), at 508. One or more actions may be established in association with one or more predetermined recidivism scores (or other measure of a likelihood of recidivism); in some embodiments, no actions may be recommended if the probability of recidivism does not exceed a predetermined threshold. For example, if a recidivism score is calculated in a manner resulting in a score between 0 and 1, a score less than or equal to 0.1 may not be associated with any recommended actions, while a score greater than 0.1 may be associated with one or more recommended actions. In another example, a score less than or equal to 0.1 may be considered a “low” likelihood of recidivism, and a score greater than 0.1 may be considered a “high” likelihood of recidivism. Of course, any number of gradations, tiers or ranges for indicating a likelihood of recidivism may be provided for (e.g., high, medium, and low), with respective corresponding recommended actions, as desired for any particular implementation.

According to some embodiments, an action or actions may be categorized or grouped for recommendation or intervention in predetermined circumstances. Accordingly, in some embodiments, a set of one or more recommended actions may be associated with a particular likelihood of recidivism or probability range and/or one or more other criteria. For example, if a high probability of recidivism is determined for a certain person, appropriate general recommendations or scenarios may include one or more of: return to work at full duty, return to work with restrictions, released (but there is no work available), and released (but the person refuses to return to work). In one example, a set of actions may be recommended to facilitate a return of an injured worker to full duty where a “high” score for likelihood of recidivism is determined and the worker actually returned to modified duty. In another example, a set of actions may be recommended to facilitate a return to work with restricted duty where a “high” score for likelihood of recidivism is determined and the worker has not yet actually returned to work at all, but modified duty is available. In another example, a set of actions may be recommended where a “high” score for likelihood of recidivism is determined, the worker has not returned to work of any kind and no modified duty is available. In another example, a set of actions may be recommended where a “high” score for likelihood of recidivism is determined and the worker is released medically for duty, but the worker refuses to return to work.

Recommended actions or interventions may be presented, as discussed with respect to various embodiments in this disclosure, to a medical case manager, health care professional and/or claim professional of an insurance carrier assigned to a claim and responsible for facilitating an injured person's return to work and/or reducing the likelihood of recidivism for a given case. In one example, the following table (Table 1) outlines some example recommended actions corresponding to four different scenarios A-D:

A. Return to Work - Full Duty
Congratulate the employee
Have employee complete Home Exercise Survey
Have employee complete Pain Survey
Encourage employee's compliance with treatment
Discuss return to work concerns or issues with
employee
Encourage employer to facilitate transition
Encourage employer to receive a visit from risk
control
Explore availability of wellness program for
employer
Encourage medical provider to provide home
exercise
Set up post-return to work appointment for
employee with medical provider
B. Return to Work with Restrictions
Congratulate the employee
Assure the injured person is progressing
Have employee complete Pain Survey
Discuss need of employer to adhere to restrictions
on work duty
Develop with the employer a plan to transition to
full duty
Encourage employer's strong support of injured
employee
Discuss with medical provider a treatment plan to
transition to full duty
C. Released but No Work Available
Have employee complete Home Exercise Survey
Have employee complete Pain Survey
Discuss transitional work program with employer
Discuss not for profit program with employer
Refer employer to risk control to conduct a visit
Discuss functional capacities with medical
provider
Discuss MMI and discharge of employee from
care
D. Released but Refuses Return to Work
Discuss resolution of injured employee's claim
Encourage the employer to keep the job offer
open
Discuss MMI and discharge the employee from
medical care
Discuss strategy to resolve claim with insurer's
legal department

According to one example system, a recidivism prevention system is integrated as a module or sub-system of a centralized management system, such as a workers' compensation claim management system. Integration with a claim management system may allow advantageously for pre-filling, in a user interface for the recidivism prevention system, information retrieved from the claim management system, such as name, claim number, employer, state and/or ZIP code, and may further provide for storing the recidivism assessment results with the main claim file in the claim management system. For example, in an integrated system that may be utilized for reviewing and/or entering claim information, it may not be necessary for a user to enter a claim number or other claim identifier specifically for the purposes of assessing a likelihood of recidivism and/or receiving one or more recommended actions for reducing a likelihood of recidivism (e.g., for a claim, for a patient). In some embodiments, information captured or accessed with respect to a claim (even if not specifically for the purpose of assessing a likelihood of recidivism) may be analyzed for a likelihood of recidivism in response to a user initiating the analysis and/or automatically by a recidivism module or service (e.g., periodically, such as in a batch process, and/or in response to one or more particular types of information being entered into a claim file). In some embodiments, a recidivism prevention system may transmit a notification of one or more of: a determined need to conduct a recidivism analysis (e.g., in response to entry or determination of one or more types of claim information, in response to passage of a predetermined period of time), an indication of the ability to conduct a recidivism analysis via the system (e.g., by displaying a pop-up message, by activating a button or tab of a user interface for initiating the assessment), an indication of a determined likelihood of recidivism (e.g., based on analysis conducted automatically and/or in the background in accordance with one or more embodiments), and/or an indication of one or more recommended actions for preventing or reducing the likelihood of recidivism. Such notifications may comprise, without limitation, displaying a message via a user interface and/or transmitting a message, such as an email, to one or more users. According to one example system, a recidivism prevention system includes a web service comprising an interface enabling communication between and among distributed applications. Web services typically enable cross-platform integration by enabling applications that are written in various programming languages to communicate by using a standard web-based protocol, such as Simple Object Access Protocol (SOAP). In one example, a client such as a web application or desktop application communicates using SOAP and/or HTTP with a web service (e.g., using Java® or Microsoft® .NET code. The web service communicates with one or more servers such as a SAS Stored Process Server or SASA Metadata Server.

According to one example system, a recidivism calculator software tool or utility allows for the pre-filling of as much model input data as possible from existing claim data sources, in order to reduce the data input burden on the claim/medical professional. Along with the recidivism likelihood score, the tool preferably provides a claim/medical professional with a list of recommended interventions if the score indicates a high likelihood of recidivism. Preferably, the tool also has the capability to record which recommended actions a claim/medical professional undertook based upon the recidivism calculator's suggestions, and display these recommendations to the user during subsequent uses of the tool.

According to some embodiments, when a claim/medical professional receives a return to work (RTW) release from a medical care provider, the professional may access the recidivism calculator tool to evaluate the likelihood that the claimant has a high potential for recidivism. Upon entering the tool, the user may be prompted to enter a claim number. The claim number may then be used to retrieve data from a claim management system (or other data source that contains the appropriate data) that is needed to calculate the probability of recidivism, or to retrieve previous data input if this is not the first time that claim number has been entered. In some embodiments, if a claimant actually experiences recidivism (if a new disability period is opened), the tool may be used to submit and store information about the new disability period. If it is not the first time a claim number has been entered into the tool, a message. (e.g., via a pop-up box) may be used to ask the user if the claimant has begun a second disability period. If the answer to that question is yes, the user should be presented immediately with recidivism recommendations. In one embodiment, actions suggested for actual recidivism may include one or more of: referring the case to medical case management (if not auto referred); contacting the care provider to discuss a potential for gym membership, a physical therapy program, diagnostics, and/or second opinions; and contacting the injured worker to discuss any concerns or issues.

According to some embodiments, the data items may be arranged by subject matter (e.g., with each subject group contained in frames). Data items may be updatable by the user, in some embodiments, to ensure that the tool has the most accurate information to use in the calculation process.

Any or all of methods 300, 400, and 500 may involve one or more interface(s), and the methods may include, in some embodiments, providing an interface through which a user may be allowed to enter one or more of an identifier that identifies a claim, a type of injury, an age of an injured person, at least one comorbidity condition, an insurance line of business, a gender of an injured person, geographic region, employment status, and/or any other information about a claim, person, employment, or injury associated with a claim.

According to one example method, a user (e.g., a claim professional) responsible for handling a claim for a bodily injury accesses (e.g., using a smartphone, desktop or laptop computer) a user interface for assessing a likelihood of recidivism with respect to a claim. The user interface may be implemented, for example, as a spreadsheet in a spreadsheet application, as a smartphone application and/or as a component or module of a centralized, claim data entry system. The interface includes form fields and other interface elements allowing the claim professional to enter data associated with the claim. The claim professional enters a claim number (e.g., into a text box). The user requests claim information associated with the claim number (e.g., by clicking a button that calls a method of a web service for pulling related claim information). The called method accepts the claim number as input, pulls corresponding information from one or more data sources, and returns the information to the client application, which populates one or more fields with the retrieved information. In one example, data may be retrieved by the web service from one or more data storage devices.

Continuing with the example method, the user examines the returned information (e.g., as displayed via the user interface), makes any necessary corrections and adds additional information, where available, to improve accuracy and completeness. In some instances, the user (e.g., a medical case manager) may have more current or accurate information (e.g., based on conversations with a worker and/or an employer) than may have been returned from the one or more databases. The user then initiates a scoring method via the web service (e.g., by clicking a corresponding button of the interface). The scoring method takes all the fields from the front-end interface as input, performs a transformation on the fields to create binary variables pertaining to ranges and values expected by the scoring model, applies factors to the transformed data, determines a score which is predictive of recidivism using a logistic regression method (e.g., proc logistic), and returns the score (e.g., displayed via the interface). According to the example, scores >=0.1 are displayed as “High” (indicating a higher likelihood of recidivism) and scores below 0.1 are displayed as “Low” (indicating a lower likelihood of recidivism). The method further may include returning a set of one or more recommended actions (e.g., if the score is “High”) selectable via the interface. The user may select one or more of the indicated recommended actions (e.g., by checking an associated checkbox element of the interface). The user initiates a save method of the web service (e.g., by clicking a corresponding button element of the interface) and the save method takes all fields from the front-end interface, as well as the raw recidivism score and any user-selected activities, as input, and saves a corresponding record including the information to a dataset (e.g., an SAS dataset). According to the example, a user may save results for any recidivism calculations, regardless of the calculated score (e.g., whether “High” or “Low”).

According to one embodiment, a user may further initiate a history process of the web service that accepts the claim number as input and returns all recidivism assessment records that have been saved in association with the claim number, the records including at least the recidivism score and any user-selected activities).

FIG. 6A and FIG. 6B illustrate an example interface 600 through which a user (e.g., a claim professional, a medical care manager), computer, and/or application may determine a likelihood of recidivism and/or a recommended activity to reduce a likelihood of recidivism, with respect to an injured worker and an associated workers' compensation claim. In particular, a user may enter, change, receive and/or transmit information about an injured worker and the associated workers' compensation claim, such as one or more of: a claim number 602, a claimant's first name 604 and last name 606, a notice of loss date 608, an accident date 610, a benefit state 612, a date of attorney representation 614, and a date the claim was transferred from a medical only claim to a lost time claim 616. The example interface 600 further provides for a button to retrieve claim information 618 (e.g., based on the claim number 602 and/or claimant name information 604, 606). For example, as discussed in this disclosure, a claim number may be input to a process of a web service that uses the claim number to retrieve related information stored in one or more datasets and returns the retrieved information to the interface 600 (e.g., filling in one or more of the example fields of interface 600).

The example interface 600 further provides for a date of birth 620, a gender 622, a marital status 624, and a market segment indication 626. Some types of market segments may include, without limitation, commercial accounts, commercial accounts non-standard, commercial other, construction, third party administrator (e.g., for other insurance carriers), national accounts, select, residual markets, and other.

The example interface 600 further provides for a date of hire 628, an indication of physical demands of the claimant's employment 630, an average weekly wage 632, a compensation rate 634, an indication of whether salary is continued 636 (e.g., Yes, No), an indication of whether there was a witness to the accident 638 (e.g., Yes, No), an indication of whether the claimant does not speak English 640 (e.g., Yes, No), an indication of the claimant's employment status 642 (e.g., full time, part time, other), an indication of whether there was a change in the primary diagnosis 644 (e.g., Yes, No), and a diagnosis code 646. Some types of physical demands may include, without limitation, none or unknown, sedentary, low, medium (e.g., up to 50 lbs.), heavy, and very heavy.

The example interface 600 further provides for an indication of whether there was a similar injury 648 (e.g., Yes, No), an indication of a primary comorbidity 650 of the injured person, an indication of whether there is a second comorbidity 652 of the injured person (e.g., Yes, No), an SIC code 654, a date a medical case manager was assigned to the claim 656, an indication of whether surgery was performed 658 (e.g., Yes, No), and an indication of initial treatment of the person's medical condition 660. Some examples of initial treatment include, without limitation, none or unknown, minor on-site remedies by employer medical staff (first aid), minor clinical/hospital medical remedies and diagnostic testing, emergency evaluation, diagnostic testing and medical procedures, hospitalization >24 hours, and invalid treatment.

The example interface 600 further provides for a current full duty release target 662, a full duty return to work (RTW) date 664, an indication of whether there is an actual modified duty RTW 666 (e.g., Yes, No), an indication of whether there is a modified duty available for the restrictions provided 668 (e.g., Yes, No), and an indication of whether the injured worker is expected to return to work if modified duty is available (e.g., Yes, No) 670. In some embodiments, the following questions may be contingent upon answers to other questions: “Is a modified duty available for the restrictions provided?” and “Do you expect IW to RTW if modified duty is available?” For example, the contingent questions may only be provided, in some embodiments, if actual modified duty RTW is “No,” and the full duty RTW date is confirmed (e.g., by a user via a checkbox) to be unavailable.

The example interface 600 further provides for a button for initiating calculating a recidivism score 680 based on the information in the interface 600. Various ways of deriving a recidivism score or other indication of a likelihood of recidivism are described in this disclosure. Clicking the button 680 may, for example, call a method of a web service using some or all of the information entered in the interface 600 as input. After the recidivism score is calculated, an indication of the likelihood of recidivism 682 is presented via the interface 600. In some embodiments, the indication may comprise a relative indication or description (e.g., “High,” “Low,” or “Medium), a color, an alphanumeric rating, rank or score, or any other indicia desirable to indicate a likelihood of recidivism for a particular implementation. In the example interface 600 of FIG. 6B, the recidivism potential is indicated as “LOW.” According to some embodiments, as discussed in this disclosure, actuating the calculate recidivism score button 680 may further provide for presenting at least one recommended action based on the determined recidivism score, via the interface 600. In one embodiment, a checkbox or other user-selectable element is presented in association with each recommended action displayed via the interface 600, allowing the user to select which action or actions, if any, the user would like to associate with the claim.

The example interface 600 also includes an interface element allowing a user to reset or clear the interface form fields, the reset the form button 690. The example interface 600 also includes an interface element, the get history button 692, allowing the user to request previously Saved records including recidivism information (e.g., from a central computer), which may be displayed via the interface 600. The example interface 600 also includes an interface element, the submit and save button 694, allowing the user to save information entered and/or presented via the interface 600, including any determined recidivism score and/or recommended activities, in association with the claim.

Although certain types of information are illustrated in the example interface 600, those skilled in the art will understand that the interface 600 may be modified in order to provide for additional types of and/or to remove some of the illustrated types of information, as deemed desirable for a particular implementation.

Those skilled in the art will readily understand, in light of the present disclosure, that the features and information described with respect to interface 600, including the indicated form fields and the potential recommended actions, or a subset of such features and information, may be included in a single interface, screen display or application window, or may be presented using multiple such interfaces, displays or windows. For example, a single interface window may be used for inputting relevant claim information and displaying determined recidivism scores and recommended procedures on the same screen, tab or page of the interface.

Throughout the description and unless otherwise specified, the following terms may include and/or encompass the example meanings provided below. These terms and illustrative example meanings are provided to clarify the language selected to describe embodiments both in the specification and in the appended claims, and accordingly, are not intended to be limiting.

As used in this disclosure, the term “recidivism” may refer, in some embodiments, to recurrence, re-injury, exacerbation, aggravation, or relapse of an initial medical condition or injury of a patient or injured worker (e.g., after receiving initial medical treatment) and/or an occurrence of a new injury or medical condition in a previously injured or ill person (e.g., an injured worker cleared medically to return to work). As used in this disclosure, “claim recidivism” may refer, in some embodiments, to those insurance claims (e.g., in a workers' compensation insurance context) where an injured worker failed at an attempt to return to work (e.g., after an initial injury) for any health, medical or other reason, resulting in more than one disability period. The cause of the claim recidivism may be, for example and without limitation, aggravation or relapse of an initial injury that caused an initial disability period and/or occurrence of a different injury or medical condition (e.g., that may or may not be related to an initial injury). Alternatively, or in addition, the term “recidivism” may refer, in some embodiments, to a tendency (e.g., of a patient, of an injured worker) to relapse into a previous condition or mode of behavior, where the previous condition or mode may include, without limitation, an initial medical condition or an inability to work. In some embodiments, recidivism may refer specifically to a recurrence, re-injury, exacerbation, aggravation, or relapse of an initial medical condition or injury of a patient or injured worker (and not to a new injury or medical condition).

Some embodiments are associated with a “coefficient” or a “multiplier”. As used herein, the terms “coefficient” and “multiplier” may be used interchangeably and may refer to any stored or derived value that may be used to modify or multiply a base or initial value. In one example, a coefficient based on an age of an injured person may be multiplied by a base number to determine an indication of a likelihood of recidivism in an injured person's medical condition. A multiplier may include, in some embodiments, values less than, equal to, and/or greater than 1.00. For example, in some embodiments an appropriate multiplier or coefficient for a desired baseline patient population (e.g., patients under 40 years of age, patients with no comorbidity conditions) may be set at 1.00. Accordingly, applying a multiplier may comprise multiplying by 1.00, or, in some embodiments, not multiplying by the multiplier if the value is exactly 1.00 (e.g., using a first or base value as a second or final value).

Some embodiments are associated with a “factor” and/or “consideration”, such as an age factor, age consideration, employment factor, gender factor, comorbidity factor or comorbidity consideration. The terms “factor” and “consideration” may be used interchangeably and may refer to a description of such factor (e.g., a comorbidity condition of obesity) and/or to a value of such factor (e.g., a physical demands factor may comprise a multiplier value of 1.23).

Numerous embodiments are described in this disclosure, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments nor a listing of features of the invention that must be present in all embodiments.

Neither the Title (set forth at the beginning of the first page of this disclosure) nor the Abstract (set forth at the end of this disclosure) is to be taken as limiting in any way as the scope of the disclosed invention(s).

The phrase “based on” does not mean “based only on”, unless expressly specified otherwise. In other words, the phrase “based on” describes both “based only on” and “based at least on”.

When a single device or article is described herein, more than one device or article (whether or not they cooperate) may alternatively be used in place of the single device or article that is described. Accordingly, the functionality that is described as being possessed by a device may alternatively be possessed by more than one device or article (whether or not they cooperate).

Similarly, where more than one device or article is described herein (whether or not they cooperate), a single device or article may alternatively be used in place of the more than one device or article that is described. For example, a plurality of computer-based devices may be substituted with a single computer-based device. Accordingly, the various functionality that is described as being possessed by more than one device or article may alternatively be possessed by a single device or article.

The functionality and/or the features of a single device that is described may be alternatively embodied, by one or more other devices that are described but are not explicitly described as having such functionality and/or features. Thus, other embodiments need not include the described device itself, but rather can include the one or more other devices which would, in those other embodiments, have such functionality/features.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

“Determining” something can be performed in a variety of manners and therefore the term “determining” (and like terms) includes calculating, computing, deriving, looking up (e.g., in a table, database or data structure), ascertaining, recognizing, and the like.

A “display” as that term is used herein is an area that conveys information to a viewer. The information may be dynamic, in which case, an LCD, LED, CRT, Digital Light Processing (DLP), rear projection, front projection, or the like may be used to form the display. The aspect ratio of the display may be 4:3, 16:9, or the like. Furthermore, the resolution of the display may be any appropriate resolution such as 480i, 480p, 720p, 1080i, 1080p or the like. The format of information sent to the display may be any appropriate format such as Standard Definition Television (SDTV), Enhanced Definition TV (EDTV), High Definition TV (HDTV), or the like. The information may likewise be static, in which case, painted glass may be used to form the display. Note that static information may be presented on a display capable of displaying dynamic information if desired. Some displays may be interactive and may include touch screen features or associated keypads as is well understood.

The present disclosure may refer to a “control system”. A control system, as that term is used herein, may be a computer processor coupled with an operating system, device drivers, and appropriate programs (collectively “software”) with instructions to provide the functionality described for the control system. The software is stored in an associated memory device (sometimes referred to as a computer readable medium). While it is contemplated that an appropriately programmed general purpose computer or computing device may be used, it is also contemplated that hard-wired circuitry or custom hardware (e.g., an application specific integrated circuit (ASIC)) may be used in place of, or in combination with, software instructions for implementation of the processes of various embodiments. Thus, embodiments are not limited to any specific combination of hardware and software.

A “processor” means any one or more microprocessors, Central Processing Unit (CPU) devices, computing devices, microcontrollers, digital signal processors, or like devices. Exemplary processors are the INTEL PENTIUM or AMD ATHLON processors.

As used herein, the term “network component” may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network”. As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration of type that is or becomes known. Communication networks may include, for example, one or more networks configured to operate in accordance with the Fast Ethernet LAN transmission standard 802.3-2002® published by the Institute of Electrical and Electronics Engineers (IEEE). In some embodiments, a network may include one or more wired and/or wireless networks operated in accordance with any communication standard or protocol that is or becomes known or practicable.

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

The term “computer-readable medium” refers to any statutory medium that participates in providing data (e.g., instructions) that may be read by a computer, a processor or a like device. Such a medium may take many forms, including but not limited to non-volatile media, volatile media, and specific statutory types of transmission media. Non-volatile media include, for example, optical or magnetic disks and other persistent memory. Volatile media include DRAM, which typically constitutes the main memory. Statutory types of transmission media include coaxial cables, copper wire and fiber optics, including the wires that comprise a system bus coupled to the processor. Common forms of computer-readable media include, for example, a floppy disk, a flexible disk, hard disk, magnetic tape, any other magnetic medium, a CD-ROM, Digital Video Disc (DVD), any other optical medium, punch cards, paper tape, any other physical medium with patterns of holes, a RAM, a PROM, an EPROM, a FLASH-EEPROM, a USB memory stick, a dongle, any other memory chip or cartridge, a carrier wave, or any other medium from which a computer can read. The terms “computer-readable memory” and/or “tangible media” specifically exclude signals, waves, and wave forms or other intangible or transitory media that, may nevertheless be readable by a computer.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols. For a more exhaustive list of protocols, the term “network” is defined below and includes many exemplary protocols that are also applicable here.

It will be readily apparent that the various methods and algorithms described herein may be implemented by a control system and/or the instructions of the software may be designed to carry out the processes of the present invention.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models, hierarchical electronic file structures, and/or distributed databases) could be used to store and manipulate the data types described herein. Likewise, object methods or behaviors of a database can be used to implement various processes, such as those described herein. In addition, the databases may, in a known manner, be stored locally or remotely from a device that accesses data in such a database. Furthermore, while unified databases may be contemplated, it is also possible that the databases may be distributed and/or duplicated amongst a variety of devices.

As used herein, the term “network component” may refer to a user or network device, or a component, piece, portion, or combination of user or network devices. Examples of network components may include a Static Random Access Memory (SRAM) device or module, a network processor, and a network communication path, connection, port, or cable.

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

In addition, some embodiments are associated with a “network” or a “communication network”. As used herein, the terms “network” and “communication network” may be used interchangeably and may refer to an environment wherein one or more computing devices may communicate with one another, and/or to any object, entity, component, device, and/or any combination thereof that permits, facilitates, and/or otherwise contributes to or is associated with the transmission of messages, packets, signals, and/or other forms of information between and/or within one or more network devices. Such devices may communicate directly or indirectly, via a wired or wireless medium such as the Internet, LAN, WAN or Ethernet (or IEEE 802.3), Token Ring, or via any appropriate communications means or combination of communications means. In some embodiments, a network may include one or more wired and/or wireless networks operated in accordance with any communication standard or protocol that is or becomes known or practicable. Exemplary protocols include but are not limited to: Bluetooth™, Time Division Multiple Access (TDMA), Code Division Multiple Access (CDMA), Global System for Mobile communications (GSM), Enhanced Data rates for GSM Evolution (EDGE), General Packet Radio Service (GPRS), Wideband CDMA (WCDMA), Advanced Mobile Phone System (AMPS), Digital AMPS (D-AMPS), IEEE 802.11 (WI-FI), IEEE 802.3, SAP, the best of breed (BOB), system to system (S2S), the Fast Ethernet LAN transmission standard 802.3-2002® published by the Institute of Electrical and Electronics Engineers (IEEE), or the like. Networks may be or include a plurality of interconnected network devices. In some embodiments, networks may be hard-wired, wireless, virtual, neural, and/or any other configuration of type that is or becomes known. Note that if video signals or large files are being sent over the network, a broadband network may be used to alleviate delays associated with the transfer of such large files, however, such is not strictly required. Each of the devices is adapted to communicate on such a communication means. Any number and type of machines may be in communication via the network. Where the network is the Internet, communications over the Internet may be through a website maintained by a computer on a remote server or over an online data network including commercial online service providers, bulletin board systems, and the like. In yet other embodiments, the devices may communicate with one another over RF, cable TV, satellite links, and the like. Where appropriate encryption or other security measures such as logins and passwords may be provided to protect proprietary or confidential information.

Communication among computers and devices may be encrypted to insure privacy and prevent fraud in any of a variety of ways well known in the art. Appropriate cryptographic protocols for bolstering system security are described in Schneier, APPLIED CRYPTOGRAPHY, PROTOCOLS, ALGORITHMS, AND SOURCE CODE IN C, John Wiley & Sons, Inc. 2d ed., 1996, which is incorporated by reference in its entirety.

It will be readily apparent that the various methods and algorithms described herein may be implemented by, e.g., appropriately programmed general purpose computers and computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software. Accordingly, a description of a process likewise describes at least one apparatus for performing the process, and likewise describes at least one computer-readable medium and/or memory for performing the process. The apparatus that performs the process can include components and devices (e.g., a processor, input and output devices) appropriate to perform the process. A computer-readable medium can store program elements appropriate to perform the method.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

1. An apparatus comprising:
a processor; and
a computer-readable memory in communication with the processor, the computer-readable memory storing instructions that when executed by the processor result in:
determining information about a medical condition of a person;
determining at least one of: personal information associated with the person, claim information associated with the person, and employment information associated with the person; and
determining an indication of a likelihood of recidivism for the person based on (i) the information about the medical condition and (ii) at least one of the personal information, claim information, and employment information.

2. The apparatus of claim 1, wherein determining the indication of the likelihood of recidivism comprises:
generating a recidivism score.

3. The apparatus of claim 1, wherein determining the information about the medical condition comprises:
determining at least one of: an injury type, an indication of a similar injury, an indication of an initial treatment of the medical condition, an indication of a change in a primary diagnosis, at least one comorbidity of the person, an indication of a diagnosis code, and an indication of whether a surgery was performed on the person.

4. The apparatus of claim 1, wherein determining the personal information comprises:
determining at least one of: a date of birth of the person, a gender of the person, an indication of whether the person speaks a predetermined language, and a marital status of the person.

5. The apparatus of claim 1, wherein determining the claim information comprises:
determining at least one of: a date of an accident involving the person, a geographical jurisdiction associated with a claim, an indication of whether there was a witness to an injury, a date of attorney representation, a current full duty release target date, an SIC code, a full duty return to work date, an indication of whether there was an actual modified duty return to work, an indication of whether modified duty is available, and an indication of whether the person is expected to return to work if modified duty is available.

6. The apparatus of claim 1, wherein determining the employment information comprises:
determining at least one of: a date of hire of the person, an indication of physical demand of the person's employment, an average wage, a compensation rate, an indication of whether salary is continued, and an employment status.

7. The apparatus of claim 1, wherein determining the indication of the likelihood of recidivism comprises:
determining a respective coefficient for each of a plurality of characteristics, based on at least one of the information about the medical condition, the personal information, the employment information and the claim information; and
calculating a recidivism score based on the plurality of respective coefficients.

8. The apparatus of claim 1, the computer-readable memory storing instructions that when executed by the processor further result in:
determining at least one action based on the likelihood of recidivism.

9. A computer readable memory storing instructions that when executed by a computer comprising at least one processor result in:
determining, by the computer, information about a medical condition of a person;
determining, by the computer, at least one of: personal information associated with the person, claim information associated with the person, and employment information associated with the person; and
determining, by the computer, an indication of a likelihood of recidivism for the person based on (i) the information about the medical condition and (ii) at least one of the personal information, claim information, and employment information.

10. The computer readable memory of claim 9, wherein determining the indication of the likelihood of recidivism comprises:
generating a recidivism score.

11. The computer readable memory of claim 9, wherein determining the information about the medical condition comprises:
determining at least one of: an injury type, an indication of a similar injury, an indication of an initial treatment of the medical condition, an indication of a change in a primary diagnosis, an indication of a diagnosis code, and an indication of whether a surgery was performed on the person.

12. The computer readable memory of claim 9, wherein determining the personal information comprises:
determining at least one of: a date of birth of the person, a gender of the person, at least one comorbidity of the person, an indication of whether the person speaks a predetermined language, a marital status of the person.

13. The computer readable memory of claim 9, wherein determining the claim information comprises:
determining at least one of: a date of an accident involving the person, a geographical jurisdiction associated with a claim, an indication of whether there was a witness to an injury, a date of attorney representation, a current full duty release target date, an SIC code, a full duty return to work date, an indication of whether there was an actual modified duty return to work, an indication of whether modified duty is available, and an indication of whether the person is expected to return to work if modified duty is available.

14. The computer readable memory of claim 9, wherein determining the employment information comprises:
determining at least one of: a date of hire of the person, an indication of physical demand of the person's employment, an average wage, a compensation rate, an indication of whether salary is continued, and an employment status.

15. The computer readable memory of claim 9, wherein determining the indication of the likelihood of recidivism comprises:
determining a respective coefficient for each of a plurality of characteristics, based on at least one of the information about the medical condition, the personal information, the employment information and the claim information; and
calculating a recidivism score based on the plurality of respective coefficients.

16. The computer readable memory of claim 9, further comprising instructions that when executed by a computer comprising at least one processor result in:
determining, by the computer, at least one action based on the likelihood of recidivism.

17. The computer readable memory of claim 9, further comprising instructions that when executed by a computer comprising at least one processor result in:
presenting, by the computer, the likelihood of recidivism via a user interface.

18. A method comprising:
determining, by a specially-programmed computerized processing device, information about a medical condition of a person;
determining, by the specially-programmed computerized processing device, at least one of: personal information associated with the person, claim information associated with the person, and employment information associated with the person; and
determining, by the specially-programmed computerized processing device, an indication of a likelihood of recidivism for the person based on (i) the information about the medical condition and (ii) at least one of the personal information, claim information, and employment information.

19. The method of claim 18, wherein determining the indication of the likelihood of recidivism comprises:
generating a recidivism score.

20. The method of claim 18, wherein determining the information about the medical condition comprises:
determining at least one of: an injury type, an indication of a similar injury, an indication of an initial treatment of the medical condition, an indication of a change in a primary diagnosis, an indication of a diagnosis code, and an indication of whether a surgery was performed on the person.

21. The method of claim 18, wherein determining the personal information comprises:
determining at least one of: a date of birth of the person, a gender of the person, at least one comorbidity of the person, an indication of whether the person speaks a predetermined language, a marital status of the person.

22. The method of claim 18, wherein determining the claim information comprises:
determining at least one of: a date of an accident involving the person, a geographical jurisdiction associated with a claim, an indication of whether there was a witness to an injury, a date of attorney representation, a current full duty release target date, an SIC code, a full duty return to work date, an indication of whether there was an actual modified duty return to work, an indication of whether modified duty is available, and an indication of whether the person is expected to return to work if modified duty is available.

23. The method of claim 18, wherein determining the employment information comprises:
determining at least one of: a date of hire of the person, an indication of physical demand of the person's employment, an average wage, a compensation rate, an indication of whether salary is continued, and an employment status.

24. The method of claim 18, wherein determining the indication of the likelihood of recidivism comprises:
determining a respective coefficient for each of a plurality of characteristics, based on at least one of the information about the medical condition, the personal information, the employment information and the claim information; and
calculating a recidivism score based on the plurality of respective coefficients.

25. The method of claim 18, further comprising:
determining, by the specially-programmed computerized processing device, at least one action based on the likelihood of recidivism.

26. The method of claim 18, further comprising: presenting, by the specially-programmed computerized processing device, the likelihood of recidivism via a user interface.

27. A method comprising:
determining, by a specially-programmed computerized processing device, information associated with a person having a medical condition;
determining, by the specially-programmed computerized processing device, a likelihood of recidivism for the person based on the determined information; and
determining, by the specially-programmed computerized processing device, at least one recommended action based on the likelihood of recidivism.

28. A method comprising:
determining, by a specially-programmed computerized processing device, historical data including information about persons having medical conditions and respective recidivism for the persons;
deriving, by the specially-programmed computerized processing device, a coefficient for at least one data parameter based on the information about the persons and the recidivism information;
storing, by the specially-programmed computerized processing device, an indication of the coefficient in association with the at least one data parameter; and
storing, by the specially-programmed computerized processing device, recommendation data including at least one recommended action for preventing recidivism, in association with a predetermined likelihood of recidivism.
